(19) United States
(12) Patent Application Publication
(10) Pub. No.: US 2021/0388546 A1
(43) Pub. Date: Dec. 16, 2021

(54) HOLLOW CYLINDRICAL CARBON FIBRE CONSTRUCTION

(71) Applicant: SGL CARBON SE, Wiesbaden (DE)

(72) Inventors: Almut SCHWENKE, Meitingen (DE); Manfred JUNG, Meitingen (DE); Oswin OETTINGER, Meitingen (DE); Rainer SCHMITT, Meitingen (DE)

(73) Assignee: SGL CARBON SE, Wiesbaden (DE)

(21) Appl. No.: 17/283,891

(22) PCT Filed: Oct. 8, 2019
(86) PCT No.: PCT/EP2019/077209

§ 371 Date: Apr. 8, 2021

(30) Foreign Application Priority Data
Oct. 9, 2018 (DE) 10 2018 217 237.4

(51) Int. Cl. D04H 1/4242; D04H 1/76

(52) U.S. Cl. CPC D04H 1/4242; D10B 2101/12; D10B 2321/10; D04H 1/76

(57) ABSTRACT

A hollow cylindrical carbon fiber construction, including a carbon fiber nonwoven, which is continuous between the inner lateral surface and the outer lateral surface of the carbon fiber construction all around. The hollow cylindrical carbon fiber construction can be obtained by a method in which a hollow cylindrical starting fiber construction, which includes a nonwoven that is continuous between the inner lateral surface and the outer lateral surface of the starting fiber construction all around, is subjected to a pyrolysis process.

The invention relates to a hollow cylindrical carbon fibre construction, for example a hollow cylindrical carbon fibre body, to a method for the production thereof and to the use thereof, in particular as a high-temperature insulating cylinder.

DE 10 2012 201 650 A1 describes a hollow cylindrical heat shield that comprises at least one graphite foil, on the outside of which at least one wound fibre structure is provided. The fibre structure has a degree of coverage of less than 100%. The wound fibre structure may be selected inter alia from cords, twines, yarns, rovings, nonwoven fabrics, woven fabrics, warp-knitted fabrics, weft-knitted fabrics and felts. On the inside of the at least one graphite foil, at least one layer made of a fibre composite material can be provided, the fibre structure of which may in turn be selected inter alia from rovings, nonwoven fabrics, woven fabrics, warp-knitted fabrics, weft-knitted fabrics and felts.

DE 100 25 628 A1 describes a method for manufacturing a component, such as a pipe, from fibre composite materials by applying at least one layer of a resin-impregnated fabric or prepreg and at least one layer of resin-soaked or resin-free wound threads, yarns, rovings or ribbons on a shaping, temporary mandrel. It also describes that one or more layers of felt may also be applied during winding. Felt made of carbon fibres, graphite fibres, cellulose fibres, polyacrylonitrile fibres and ceramic fibres are mentioned. After the winding process, carbonisation and, if necessary, graphitisation can be carried out, for example. In one of the examples, two 10 mm thick layers of graphite felt are wound up as intermediate layers. The graphite felt had a layer thickness of 10 mm. In both layers, one layer of the graphite felt was thus wound up. The weight per unit area of this felt according to DIN 53854 was 1,000 g/m². It is emphasised that the built-in layers of felt give the component excellent thermal insulation properties. It is further described that the thickness of a felt layer after winding is generally within a range of 2 to 20 mm, preferably within a range of 5 to 10 mm. Thicknesses of up to 20 mm would preferably be used if components having greater wall thicknesses are to be produced.

No further specific information on felt and/or nonwoven fabric-containing layers in hollow cylindrical heat shields and components is to be found either in DE 10 2012 201 650 A1 or in DE 100 25 628 A1.

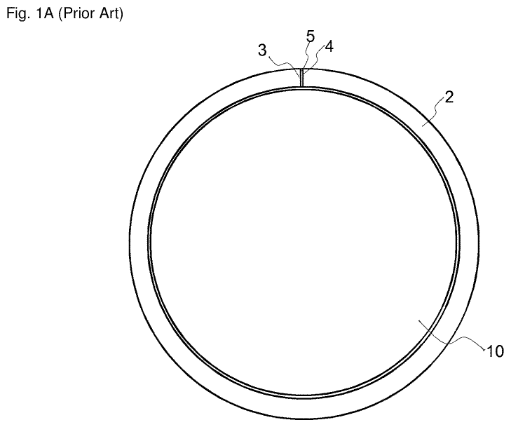

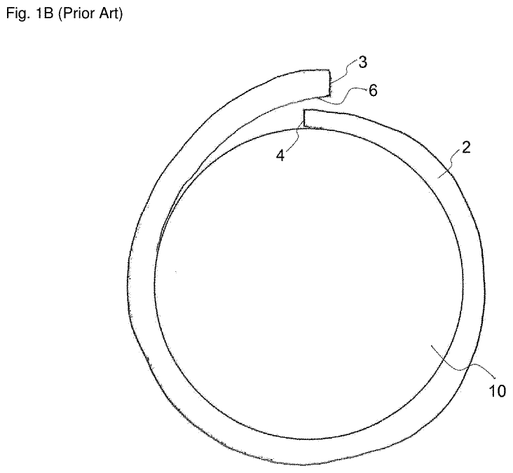

Conventional winding of the carbon fibre felt always results in a gap region or an overlap region, as FIGS. 1A and 1B illustrate herein.

FIG. 1A shows that the carbon fibre felt layer to be applied can be cut to length according to the circumference of the component in order to be able to be applied to the component in a simple position, i.e. without an overlap region. The cut surfaces of both ends of the wound layer should then run approximately parallel to one another and as close to one another as possible, as indicated in FIG. 1A. This creates a gap region that runs substantially orthogonally to the outer and inner surface of the carbon fibre felt. The gap region can be filled with carbonisable binder. The felt does not join together in the gap region because all the fibres are cut off at the cut surfaces and do not extend out from one cut surface into the other cut surface. Ideally, the gap region has exactly the same width everywhere, which width is as small as possible. In practice, however, this ideal state cannot be achieved or can only be achieved through very complex, step-by-step manual reworking of the two cut surfaces.

According to FIG. 1B, the carbon fibre felt layer to be applied can be cut to length with an excess length. It is then applied in multiple layers, i.e. with an overlap region, at least in a part of the circumference. A small overlap region is shown by way of example. The carbon fibre felt can also be wound up in multiple layers. Regardless of the size of the overlap region, the carbon fibre felt is then connected in a spiral all around because the fibres run within the spirally wound felt layer. The fibres do not run from one layer into the next layer located further outside or further inside. Regardless of the size of the overlap region and the number of layers, a layer structure that is uniform all around can never be achieved in a winding with a felt layer having an overlap such that there are always regions having better and worse thermal insulation properties.

It is true that carbon or graphite fibre felt layers of the prior art result in excellent thermal insulation properties as described in DE 100 25 628 A1. Nevertheless, there is potential for improvement. It was shown that high-temperature-treated products that were high-temperature treated in high-temperature furnaces having insulating cylinders of the prior art had undesirable defects that led to a high reject rate. This has been observed, for example, in the production of fibreglass.

DE 100 25 628 A1 and DE 10 2012 201 650 A1 each describe a wall structure comprising a plurality of layers. This incurs very high manufacturing costs. It was also shown that very frequent, sharp temperature changes can lead to delamination of the layers.

The present invention is therefore based on the object of providing an article which permits the highest possible yield of a high-temperature-treated product that conforms to specifications, is particularly durable and is particularly easy to produce. Ultimately, the article should allow a particularly effective high-temperature treatment process, also and in particular when the effort required for installing and replacing high-temperature insulation material is taken into account.

This object is achieved by a hollow cylindrical carbon fibre construction (preferably a hollow cylindrical carbon fibre body) comprising a carbon fibre nonwoven that is continuous between the inner lateral surface and the outer lateral surface of the carbon fibre construction all around.

A “hollow cylindrical carbon fibre construction” means a hollow cylindrical construction containing carbon fibres. In a preferred embodiment, the carbon fibre construction may consist substantially only of the carbon fibre nonwoven.

In the context of the present invention, “consisting substantially only of the carbon fibre nonwoven” means that the carbon fibre nonwoven contributes at least 50% by weight, preferably at least 70% by weight, particularly preferably at least 90% by weight, particularly preferably at least 95% by weight, most preferably at least 99% by weight to the total mass of the carbon fibre construction.

The carbon fibre nonwoven may also be present in a layered composite with another material. The carbon fibre construction according to the invention can therefore be a hollow cylindrical carbon fibre layered composite construction, comprising the carbon fibre nonwoven, which is continuous between the inner lateral surface and the outer lateral surface of the carbon fibre construction all around, and at least one continuous material layer arranged on the outer lateral surface and/or the inner lateral surface of the carbon fibre construction. The material layer may comprise a carbon-based material that contains, for example, at least 80% by weight of carbon. A preferred carbon fibre layered composite construction according to the invention comprises a carbon fibre-reinforced carbon tube (CFC tube) arranged on the inner lateral surface of the carbon fibre construction. Carbon fibre reinforced carbon (CFC) is a carbon fibre composite material having a carbon matrix. The carbon fibre nonwoven is preferably shrunk onto the CFC tube. The carbon matrix may also contain carbon, for example in the form of graphite. The preferred carbon fibre layered composite construction according to the invention, which comprises a CFC tube arranged on the inner lateral surface of the carbon fibre construction, may also comprise a CFC tube arranged on the outer lateral surface of the carbon fibre construction.

Carbon fibre layered composite constructions according to the invention are, for example, also the hollow cylindrical heat shields described in DE 10 2012 201 650 A1, the windable components described in DE 100 25 628 A1, the components described in DE 10 2016 219 214 A1 for high-temperature applications, if the heat shields, components or building elements described therein have the all-round continuous carbon fibre nonwoven instead of at least one of the nonwoven fabrics, felts, graphite felts, fibre layers, insulating felts, fibre fabrics, fibre nonwovens or fibre felts explicitly mentioned in these documents.

The hollow cylindrical carbon fibre construction according to the invention is preferably self-supporting. It is then referred to as a hollow cylindrical carbon fibre body. “Self-supporting” means that the hollow cylindrical carbon fibre body retains its hollow cylindrical shape under the load of its own mass. This can be tested by placing the carbon fibre construction according to the invention on a flat surface in such a way that gravitational force acts parallel to the longitudinal axis of the hollow cylindrical carbon fibre body. If the carbon fibre construction placed in this way does not fall over under the load of its own mass within 30 seconds, it is a hollow cylindrical carbon fibre body. A hollow cylindrical carbon fibre construction that is very particularly preferred according to the invention is a hollow cylindrical carbon fibre body that substantially consists only of the carbon fibre nonwoven.

However, the invention also includes hollow cylindrical carbon fibre constructions that do not retain their shape under the load of their own mass in accordance with the above test, such as carbon fibre tubes. These are referred to herein as non-self-supporting hollow cylindrical carbon fibre constructions. They take on a hollow cylindrical shape, for example, when they are pulled completely onto the lateral surface of a sufficiently long and sufficiently thick cylindrical body, such as a metal rod.

The term “hollow cylindrical” means that the invented article is hollow and cylindrical.

The term “cylindrical” refers to a geometric body in which two parallel, flat, congruent bases are connected to one another by an outer lateral surface. Two corresponding points on both base edges are connected by a line. The entirety of these parallel lines forms the outer lateral surface.

The term “hollow” means that each base has an opening to a channel penetrating the carbon fibre construction from one base to the other base. The channel is bounded all around by the inner lateral surface. In general, the areas of both openings are congruent and connected to one another by the inner lateral surface. Two corresponding points on both edges of the opening are connected by a line. The entirety of these parallel lines then forms the inner lateral surface.

The region of a base enclosed between a base edge and an opening edge is referred to as the end face.

The hollow cylindrical carbon fibre construction thus has four surfaces, an outer lateral surface, an inner lateral surface and two end faces.

The length of the carbon fibre construction is preferably at least 0.1 times, particularly preferably at least 0.2 times, most preferably at least 0.3 times the outer circumference of the carbon fibre construction. The outer circumference is measured in a plane oriented orthogonally to the longitudinal axis of the carbon fibre construction.

The end faces of the hollow cylindrical carbon fibre construction may be of any shape. They may, for example, be circular, oval or polygonal, the edges running in the outer lateral surface then being rounded. The end faces are preferably circular or oval, particularly preferably circular. These details relate in each case to the outer edge of the end faces at which the end faces merge into the outer lateral surface. However, the inner edge of the end faces is preferably also circular or oval, particularly preferably circular.

The wall thickness of the hollow cylindrical carbon fibre construction or the carbon fibre nonwoven is defined by the distance from the outer lateral surface to the inner lateral surface. For each point on the inner lateral surface, a point on the outer lateral surface that is closest to this point can be defined. The distance to the next point on the outer lateral surface defines the wall thickness at the respective point on the inner lateral surface. The wall thickness can easily be calculated for each point on the inner lateral surface based on a three-dimensional image (3D scan) of the construction according to the invention.

According to the invention, long and simultaneously thin-walled hollow cylindrical carbon fibre constructions are in particular also accessible. The wall thickness preferably does not exceed 25%, preferably 20%, particularly preferably 15%, most preferably 10% of the length of the hollow cylindrical carbon fibre carbon fibre construction anywhere.

The wall thickness is preferably constant all around. In a particularly preferred hollow cylindrical carbon fibre construction, the projection along the longitudinal axis of the carbon fibre construction into a projection plane running orthogonally to the longitudinal axis comprises two circles whose centres of gravity coincide. This is then a circular, hollow cylindrical carbon fibre construction.

It goes without saying that the actual shape of the hollow cylindrical carbon fibre construction deviates from the ideal hollow cylindrical geometry due to the manufacturing process. In particular, a settling behaviour was observed in the pyrolysis process described in more detail below. The wall thickness and/or the density of the carbon fibre nonwoven became greater in a region arranged further down during the pyrolysis process than in a region arranged further up during the pyrolysis process. This could be avoided by carrying out the pyrolysis on the horizontally mounted hollow cylindrical construction and by rotating the hollow cylindrical construction about its longitudinal axis, at least in the temperature range in which settling behaviour would occur.

The wall thickness of the carbon fibre nonwoven is preferably radially symmetrical at least in a portion of the hollow cylindrical carbon fibre construction. Two parallel sectional planes, which run orthogonally to the longitudinal axis of the hollow cylindrical carbon fibre construction, delimit the portion mentioned here. A radially symmetrical wall thickness is present when the wall thickness of the carbon fibre nonwoven is constant within the portion. “Constant” means that the wall thickness is at no point in the portion more than 10% less than at any other point in the portion. The portion preferably extends from one end face to the other end face; it then comprises the entire carbon fibre nonwoven.

The mean density of the carbon fibre nonwoven is preferably substantially radially symmetrical at least in one plane that runs orthogonally to the longitudinal axis of the hollow cylindrical carbon fibre construction. A radially symmetrical mean density is given if cylindrical samples, taken all around the plane and extending through from the inside of the carbon fibre nonwoven to the outside of the carbon fibre nonwoven, have the same mean density. The cylindrical samples can be cut out of the carbon fibre nonwoven with a sharp knife, the cut-out inner and outer surfaces of the carbon fibre nonwoven then forming the end faces of the cylindrical sample. The mean density of each sample is calculated from the mass of the sample, which is determined by weighing, and the volume of the sample. For example, eight cylindrical samples are taken all around at eight points within the plane, each point maintaining the same distance from the two nearest neighbouring points. If the mean density of the sample having the lowest mean density is at most 10% lower, preferably at most 5% lower, particularly preferably at most 3% lower than the mean density of the sample having the highest mean density, a radially symmetrical density is given. Since the density of the carbon fibre nonwoven, as described in more detail below, is often higher towards the inner lateral surface than towards the outer lateral surface, this paragraph deliberately refers to a mean density of the carbon fibre nonwoven.

A carbon fibre nonwoven is understood to be a nonwoven that contains carbon fibres. A carbon fibre is any fibre whose carbon content is at least 60% by weight, more preferably at least 80% by weight, particularly preferably at least 92% by weight, particularly preferably at least 96% by weight, particularly preferably at least 99% by weight and most preferably at least 99.5% by weight. The term “carbon fibre” here includes carbonised and graphitised fibres.

The carbon fibre nonwoven is preferably a mechanically bonded carbon fibre felt, for example a carbon fibre needle felt or a hydroentangled carbon fibre felt.

The carbon fibre nonwoven fabric preferably has a mean density within a range of 0.04 to 0.4 g/cm³, preferably within a range of 0.07 to 0.25 g/cm³, most preferably within a range of 0.07 to 0.2 g/cm³. The mean density can be determined by weighing the carbon fibre nonwoven, determining its volume and dividing the mass determined by weighing by the volume. The volume can be determined, for example, from a three-dimensional image (3D scan) that can be obtained using optical 3D technology. For example, COMET® systems from Zeiss may be used for this purpose. Densities lower than 0.04 g/cm³ are disadvantageous for many applications because the carbon fibre nonwoven having an even lower density in the case of typical wall thicknesses is no longer self-supporting and may therefore only be used with increased effort in many applications, for example in a layered composite with a supporting material. Densities higher than 0.4 g/cm³ would only be obtainable on the basis of a nonwoven having an even higher density that is continuous all around because pyrolysis generally leads to a decrease in density. Needle hardening is only possible up to a certain density. Any further needling that goes beyond this may lead to damage to the starting fibre and thus to the carbon fibre nonwoven.

In preferred carbon fibre constructions according to the invention, the carbon fibre nonwoven that is continuous all around has a tensile strength of at least 0.01 MPa, particularly preferably at least 0.025 MPa, most preferably at least 0.05 MPa. This is measured in accordance with DIN EN ISO 13934-1 with samples measuring 40 mm (width)×175 mm (length). The free clamping length of the test material was 100 mm. The tensile strength measurement is carried out transversely to the direction of needling. Comparative tests surprisingly showed that such high tensile strengths could not be achieved at all by needling starting from carbon fibre. Such high tensile strengths are only obtained when, as proposed in connection with the method according to the invention, a hollow cylindrical starting fibre construction is converted by means of pyrolysis to the carbon fibre construction according to the invention. Tensile strength is discussed in more detail below.

In particular for use in thermal insulation at high temperatures, it is advantageous if the density of the carbon fibre nonwoven in a region facing the inner lateral surface is higher (at least 2% higher, preferably at least 4% higher, particularly preferably at least 6% higher) than the density of the carbon fibre nonwoven in a region facing the outer lateral surface. Such a density distribution may easily be adjusted by shrinking the carbon fibre nonwoven onto a shaping body because the nonwoven is compressed to a greater extent close to the shaping body than further away from the shaping body. The average density of the carbon fibre nonwoven in the entire region facing the inner lateral surface is preferably higher (at least 2% higher, preferably at least 4% higher, particularly preferably at least 6% higher) than the average density of the carbon fibre nonwoven in the entire region facing the outer lateral surface. It is possible to test whether this condition is met as follows: The entire carbon fibre nonwoven is divided orthogonally with respect to the longitudinal axis of the hollow cylinder into eight equally thick portions. Each portion is then divided into twenty four pieces so that the ratio of inner surface to outer surface is as equal as possible for each piece. Then, each piece is divided into two halves of equal size, an inner half and an outer half, the cut surface maintaining the same distance from the inner surface and outer surface. Subsequently, the total volume and total mass of the inner halves as well as the total volume and total mass of the outer halves are determined and, based on this, the density of the carbon fibre nonwoven in the entire region facing the inner lateral surface and the density of the carbon fibre nonwoven in the entire region facing the outer lateral surface are determined.

It is assumed that a targeted choice of density on the inside and outside improves the thermal insulation properties in particular if a large temperature gradient is to be maintained from the inside to the outside via the carbon fibre nonwoven, as discussed below.

The high-temperature thermal conductivity, and thus the thermal insulation property, has two important components. On the one hand, the thermal insulation property is determined by the material itself, i.e. by the thermal conductivity of the fibre material. On the other hand, the thermal conductivity is determined by the overall density of the material, which influences the insulation properties through the reflection of the thermal radiation. In the region of high-temperature thermal insulation, i.e. typically at >1,000° to 2,000° C., the proportion of radiation reflection is high and a high material density is therefore advantageous.

At lower temperatures, an increasing proportion of the heat transport appears to take place via the material itself such that a low material density then results in better thermal insulation.

As a result of the shrinking-on process described in more detail here, high carbon fibre nonwoven densities are produced in a targeted manner on the inner lateral surface, resulting in a better thermal insulation effect at the particularly high temperatures prevailing on the inside. In the case of a carbon fibre construction according to the invention, the carbon fibre nonwoven, which is continuous all around, can therefore be obtained by shrinking-on.

In addition to the particularly even temperature distribution within the zone defined by the carbon fibre construction, better insulation of the furnace is also achieved all around. A temperature gradient develops from the inner lateral surface to the outer lateral surface, completely corresponding to the density gradient in the carbon fibre nonwoven. Particularly effective thermal insulation is achieved by a carbon fibre nonwoven density that is adapted to the temperature gradient and decreases from the inside to the outside of the carbon fibre nonwoven. If the density of the carbon fibre nonwoven in a region facing the inner lateral surface is higher than the density of the carbon fibre nonwoven in a region facing the outer lateral surface, this ultimately results in particularly good thermal insulation if very specific, application-specific temperature gradients are to be maintained over the carbon fibre nonwoven. This can be achieved particularly well with a radially symmetrical carbon fibre construction. A hollow cylindrical carbon fibre construction cut from a block would not have these advantageous thermal insulation properties. The density would then not decrease through the wall from the inside to the outside, but would be determined by the density distribution in the block from which the hollow cylindrical carbon fibre construction is cut. Experience has shown that the production of the block leads to high density variations within the block, which are also reflected in the wall of the hollow cylinder cut out of said block. The radially symmetrical insulating effect according to the invention would then not be achieved.

The higher density of the carbon fibre nonwoven on the inner lateral surface also has the advantage of higher mechanical strength. In the furnace, the hollow cylindrical carbon fibre nonwoven is substantially only protected from mechanical stress towards the outside by the furnace wall. A higher density of the carbon fibre nonwoven on the inner lateral surface counteracts damage caused by mechanical loads, making the furnace lining even more durable.

The proportion of carbon fibres in the carbon fibre nonwoven can contribute at least 10% by weight, preferably at least 50% by weight, particularly preferably at least 70% by weight, most preferably at least 90% by weight to the total mass of the carbon fibre nonwoven. The carbon fibre nonwoven preferably consists substantially of carbon fibres. The proportion of carbon fibres in the carbon fibre nonwoven is then at least 95% by weight, for example at least 99% by weight or 100% by weight.

The carbon fibre nonwoven may also contain other materials. In principle, all materials that do not interfere with one of the uses described herein are conceivable, for example other fibre materials and/or particles.

The carbon fibre nonwoven may contain another fibre material. The fibre material may comprise mineral fibres, for example oxide fibres and/or carbidic fibres. Oxide fibres include glass fibres, basalt fibres, aluminium oxide fibres and silicon oxide fibres. Preferred carbide fibres are silicon carbide fibres.

The carbon fibre nonwoven may contain particles, for example activated carbon particles or also catalytically active particles, such as metal particles or multi-element oxide particles, particles made of activated carbon, natural graphite flakes or graphite powder. Metals or multi-element oxides that are used on an industrial scale in the chemical industry for a wide range of heterogeneously catalysed reactions are known to a person skilled in the art. Metals or multi-element oxides that are used in catalytic converters of motor vehicles to purify the exhaust gas flow are also known to a person skilled in the art. A person skilled in the art is also familiar with metals or multi-element oxides that are used in waste incineration plants to clean the exhaust gas flow. It can be assumed that instead of the catalyst carriers usually used, carbon fibre constructions according to the invention may be used, the catalytically active material being in the form of metal particles or multi-element oxide particles that are distributed in the carbon fibre nonwoven.

According to the invention, the carbon fibre construction comprises a carbon fibre nonwoven that is continuous all around. “Continuous all around” means that the arrangement, characteristic of a nonwoven, of fibres connected to one another in an irregular manner, which occurs in a flat nonwoven web during the production of nonwovens, exists all around. If a cut is made through the carbon fibre nonwoven orthogonally to the longitudinal axis of the hollow cylindrical construction, it is not possible to see a beginning or an end of the circumferential carbon fibre nonwoven in the cut surface. In particular, there is no joint or seam in the cut surface.

The carbon fibre nonwoven may contain very thin or very thick carbon fibres or a wide range of carbon fibres of different thicknesses. The mean diameter of the fibres is preferably 3 to 20 μm, more preferably 5 to 10 μm. The mean diameter is determined microscopically.

The carbon fibres can be activated in the carbon fibre nonwoven. The activation of carbon fibres is described, for example, by INAGAKI Michio and KANG Feiyu in Materials Science and Engineering of Carbon Fundamentals, Second Edition 2014, ISBN: 978-0-12-800858-4 in section ‘a. Activated Carbon Fibers’ on pages 365 to 367 and the documents cited in this section. The carbon fibres may, for example, have a BET surface area of at most 2,000 m²/g, preferably from 1 to 1,500 m²/g, particularly preferably from 5 to 1,000 m²/g, particularly preferably from 10 to 750 m²/g, most preferably from 20 to 500 m²/g. The specific surface area according to Brunauer Emmett Teller (BET surface area) of the carbon fibre nonwoven can be determined by means of sorption of nitrogen (DIN ISO 9277; 2014-01). Hollow cylindrical carbon fibre constructions with activated carbon fibre nonwovens are particularly suitable for cleaning water and as filter materials, for example in filter candles.

The carbon fibre construction according to the invention defines a high-temperature treatment zone that is surrounded by the carbon fibre nonwoven that is continuous all around. Because the carbon fibre nonwoven is continuous all around, it has neither the gap regions nor the regions having different numbers of layers that result from conventional winding of carbon fibre felts according to FIG. 1A and FIG. 1B. As a result, an almost constant thermal insulation capacity of the surrounding carbon fibre nonwoven is made possible. It is assumed that, as a result, spatial temperature variations in the high-temperature treatment zone are also reduced. In particular, no temperature minima occur in the high-temperature treatment zone that can occur in the gap regions of the prior art mentioned at the outset. The thermal insulation is weaker in the gap regions. As a result, the entire volume or a particularly large proportion of the volume of the high-temperature treatment zone may be used efficiently without defects occurring during the high-temperature treatment as a result of insufficient exposure to high temperatures. The furnace volume installed at a site can thus ultimately be better utilised using the more homogeneous carbon fibre construction according to the invention.

The longevity of the carbon fibre construction according to the invention is high because delamination of the carbon fibre nonwoven, which is continuous all around, is not possible. Ultimately, this also contributes to better utilisation of the furnace volume installed at a site.

The carbon fibre body has to be changed less often, which means that production operations are interrupted less often.

In addition, particularly simple and cost-effective production of the carbon fibre construction according to the invention is possible using the method according to the invention. The carbon fibre construction according to the invention is obtained by means of a method in which a hollow cylindrical starting fibre construction, which comprises a nonwoven that is continuous between the inner lateral surface and the outer lateral surface of the starting fibre construction all around, is subjected to a pyrolysis process.

The pyrolysis process is carried out in such a way that the carbon content of the starting fibre construction increases and the mass of the starting fibre construction decreases. The nonwoven is converted into a carbon fibre nonwoven such that a carbon fibre construction according to the invention is created from the starting fibre construction.

The fibres of the hollow cylindrical starting fibre construction may include a wide variety of carbonisable fibres, including inter alia cellulose fibres, cellulose-based fibres such as cellulose acetate fibres or viscose fibres, polyacrylonitrile-based fibres, oxidised polyacrylonitrile-based fibres, phenolic resin fibres, polyimide fibres, pitch fibres, wool fibres or mixtures thereof. The fibres of the hollow cylindrical starting fibre construction preferably comprise polyacrylonitrile-based fibres, viscose fibres and/or pitch-based fibres. A part of the fibres of the hollow cylindrical starting fibre construction may also be non-carbonisable, such as carbon fibres, basalt fibres or glass fibres.

Depending on the fibre composition, it may be necessary to stabilise the starting fibre construction before it is subjected to the pyrolysis process. In the case of polyacrylonitrile-based fibres, stabilisation generally takes place at 200 to 300° C. in air. The polyacrylonitrile-based fibres are then converted into oxidised polyacrylonitrile-based fibres.

A hollow cylindrical starting fibre construction, which comprises a nonwoven material that is continuous between the inner lateral surface and the outer lateral surface of the starting fibre construction all around, is commercially available in a wide variety of forms, for example manufacturers of needle-punched nonwovens offer endlessly needle-punched felt tubes in a wide range of different lengths, wall thicknesses and densities.

Machines for the production of hollow cylindrical starting fibre constructions are offered by Dilo Machines GmbH, 69405 Eberbach, Germany.

Methods for the production of hollow cylindrical starting fibre constructions are described in the book ‘Vliesstoffe: Rohstoffe, Herstellung, Anwendung, Eigenschaften, Prüfung’ [Nonwovens: Raw materials, production, application, properties, testing] edition 2, 2012, ISBN 3527645888, in which, especially in sections 6.1.7.3 and 6.1.8, the BELTEX, RONTEX and OR methods suitable for the production of hollow cylindrical starting fibre constructions are described.

Devices and methods for producing hollow cylindrical starting fibre constructions are also specified in the prior art cited below.

DE 1 660 765 describes a device for producing endless paper machine felts or technical tubular felts, which device has two mutually adjustable transport rollers and a needle machine. By adjusting the distance between the two transport rollers, tubular felts having different diameters may be produced in a targeted manner.

DE 24 34 242 A1 describes a needle-felted material and a method for the production thereof. The method comprises the following steps: a) forming a continuous web of fibres; b) feeding the web in the form of a spiral to create a tube,

adjacent turns of the spiral overlapping each other; c) helically wrapping the tube as the web is fed with reinforcing fibres; d) needle felting the tube and fibres; and e) advancing the needle-felted tube progressively in the direction of the axis of the tube. In this way, a needle-felted tube is created with reinforcing threads wound in a spiral shape, which are arranged within the wall thickness of the tube.

DE 25 52 243 A1 describes a device for producing tubular felts that have a minimum diameter of only 4 to 5 mm.

Other methods of making tubular needle-felted material are described in U.S. Pat. Nos. 3,758,926 and 3,758,926.

The known methods can produce starting fibre constructions having a very wide range of different dimensions. The outer circumference of the starting fibre construction can be 20 m or more. The inner circumference can be very small, for example only 5 mm.

Circular needling allows access to starting fibre constructions having a wide range of different wall thicknesses, in particular wall thicknesses within a range of 2 to 100 mm.

In principle, hollow cylindrical fibre constructions having all producible dimensions are suitable as starting fibre constructions for the method according to the invention such that a correspondingly large bandwidth of hollow cylindrical carbon fibre constructions results.

In the production of the starting fibre construction, a continuous, uncompacted web of fibres is wound up. Mechanical solidification (e.g. circular needling) results in strong compression which, after the uncompacted web is wound, compensates for any inhomogeneities that may still exist such that a hollow cylindrical starting fibre construction having a radially symmetrical wall thickness and a radially symmetrical mean density is created.

According to the invention, depending on the fibres contained in the nonwoven and the desired carbon content, the pyrolysis typically takes place with the exclusion of oxygen and at temperatures of at least 300° C. or preferably at temperatures of at least 500° C. The pyrolysis process preferably comprises a first temperature treatment at 500 to 1,600° C., for example at 800 to 1,200° C. This first temperature treatment is called carbonisation.

The pyrolysis process may also include a second temperature treatment at 1,600 to 3,000° C., for example at 1,700 to 2,400° C. The second temperature treatment is called graphitisation. The term “carbon fibre” refers herein to fibres that can be carbonised or that can be carbonised and also graphitised.

According to a preferred method, the starting fibre construction is drawn onto a cylindrical shaping body and shrunk onto the cylindrical shaping body during the pyrolysis process.

A wide variety of shaping bodies are conceivable here.

In a preferred variant of the method, the shaping body substantially only has a shaping function. The carbon fibre construction obtained is then pulled off the shaping body after carbonisation.

For example, the carbon fibre construction obtained can be pulled off the shaping body by using a shaping body whose diameter decreases more rapidly after carbonisation during cooling than the inner diameter of the shrunk-on carbon fibre construction. The shaping body and the shrunk-on carbon fibre construction are then cooled after the pyrolysis process in order to pull the carbon fibre construction off the shaping body. In this way, a hollow cylindrical carbon fibre construction is obtained, the inner surface of which has almost exactly the same shape of the shell of the shaping body. For example, quasi completely round inner lateral surfaces may be obtained if a circular cylinder is used as the shaping body. In a high-temperature insulating cylinder having an approximately ideal surface, the temperature at which the high-temperature treatment is to take place can be set particularly precisely.

In a variant of the method that leads to the carbon fibre layered composite construction described above, the shaping body forms part of the carbon fibre construction. The shaping body (for example a CFC tube) is preferably also hollow cylindrical and forms a cohesive material layer arranged on the inside of the carbon fibre nonwoven. The shrinking-on allows the carbon fibre nonwoven to be firmly attached to a carbon-based material layer that, for example, contains at least 80% by weight of carbon. This procedure leads to a layered structure having felt layers (for example graphite felt layers), which has proven itself for example in the case of heat shields described in DE 100 25 628 A1. However, carbon fibre layered composite constructions according to the invention require little or no binder. They thus avoid the difficulties associated with using binders.

In the preferred variant of the method, in which the shaping body substantially only has a shaping function, the first temperature treatment takes place after the starting fibre construction has been drawn onto the shaping body. The carbon fibre construction obtained is pulled off the shaping body and the carbon fibre construction pulled off the shaping body can then be subjected to the second temperature treatment. It was found that a graphitised hollow cylindrical carbon fibre construction is obtained, the inner surface of which has almost exactly the same shape as the shell of the shaping body, without the shaping body having to be made of a very expensive, high-temperature-stable material that would also withstand graphitisation conditions.

The carbon fibre construction present after the first or second temperature treatment shows significantly increased mechanical stability compared to wound comparison systems in which only individual outer carbon fibre mats are solidified with one another after winding. Apparently, the brittleness and the lower resilience during mechanical solidification (e.g. circular needling) when using carbon fibres or carbon fibres nonwovens cause the fibres to break and lead to a slight compression or consolidation of the material in all regions. The lower mechanical stability was easily determined by measuring the tensile strength of carbon fibre nonwovens, especially in comparison with the values of the carbon fibre construction according to the invention.

If the tensile strength of a carbon fibre nonwoven of a hollow cylindrical carbon fibre construction according to the invention (density 0.1 g/cm³) is determined after a temperature treatment in a range of 1,700° C. to 2,400° C., values for the tensile strength in the region of 0.1 MPa are obtained. Due to the poor compression described above, a material of the same density (0.1 g/cm³) of a comparison system is so unstable that the measured values of the tensile strength (with the same sample geometry and dimensions) cannot be determined because, due to the low strength, preliminary damage already takes place when the material sample is clamped in the testing machine. However, if the maximum force up to break is taken as a basis, tensile strength values well below 0.01 MPa must be assumed.

Tensile strengths that are just as high as those of the carbon fibre nonwoven treated at high temperatures of 1,700 to 2,400° C. are to be expected in the case of hollow cylinders according to the invention that were exposed to less high temperatures during the pyrolysis process, for example only 500° C.

The BET surface area of the carbon fibres of the carbon fibre construction present after the first or second temperature treatment can be increased by gas activation. The gas activation can be carried out, for example, with carbon dioxide, water vapour or air.

The invention also comprises a carbon fibre construction obtainable by means of the method according to the invention.

The invention relates in particular to the use of the carbon fibre construction according to the invention as a high-temperature insulating cylinder.

The invention also relates to the use of the carbon fibre construction according to the invention as filter material in a filter candle. In practice, however, the application temperature of these rigid filters is usually limited to a maximum of 350° C. This opens up the possibility of producing a filter candle based on a hollow cylindrical carbon fibre construction according to the invention which, due to the lack of joints, allows for radially homogeneous filter performance. There is also potential in the field of liquid filtration, for example, for the treatment of drinking water or the filtration of corrosive mixtures because the lack of joints reduces the risk of leakage points.

The invention also relates to the use of the carbon fibre construction according to the invention as a carrier material for filter media, such as activated carbon, or as a catalyst carrier. The active component, such as activated carbon or the metal oxide, may be distributed homogeneously in the carbon fibre construction during the manufacturing process. The active component can add chemical adsorption or reactive, catalytic cleaning to mechanical filtration through a combinatorial effect. The radially homogeneous structure of the carbon fibre nonwoven accordingly leads to a homogeneous distribution of the active component and thus to an effective catalytic reaction.

The invention also relates to the use of the carbon fibre construction according to the invention as an electrode material. In the field of energy storage, tubular systems are to achieve higher efficiencies through larger electrode areas. There are research projects, for example, in the fields of fuel cells or redox flow batteries. Hollow cylindrical carbon fibre constructions according to the invention form suitable electrode materials for this purpose.

The invention also relates to the use of the carbon fibre construction according to the invention as a resistance-heating element. The electrically conductive carbon fibre construction allows heating by applying an electrical voltage. In case of use as a filter medium, the heating can limit or prevent contamination from condensation of components. Furthermore, the filter can also be used to heat the medium to be filtered, for example for liquids.

The invention also relates to the use of the carbon fibre construction according to the invention as a droplet separator or demister. Droplet separators allow the efficient separation of, for example, liquid droplets from a gas flow. Fibre mats are typically pressed between two flat metal nets (flat parallel screens) or wrapped between two cylindrical metal net rings (concentric screens). When the carbon fibre construction according to the invention is used, the more homogeneous structure achieves a significantly improved separation performance compared to laid or wound felt or fibre mats. The self-supporting structure of the active droplet separator material allows more efficient use of the entire filter surface compared to fibre mats pressed into grids, which allows the overall unit to be reduced in size.

The invention is illustrated by means of the following drawings and embodiment, without being restricted thereto.

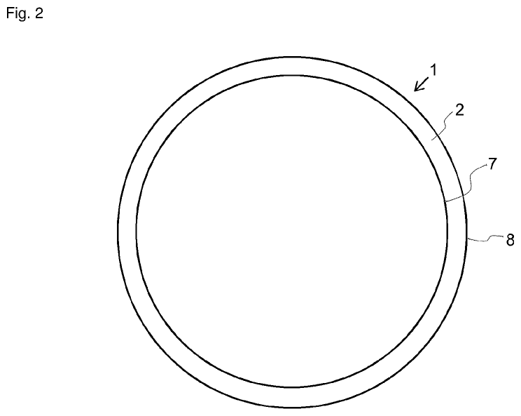

FIGS. 1A and 1B are sections through carbon fibre nonwovens not according to the invention FIG. 2 is a section through a hollow cylindrical carbon fibre construction according to the invention

FIGS. 1A and 1B illustrate known possible ways of applying carbon fibre nonwovens that are not continuous all around. For the sake of simplicity, the application on the lateral surface of a cylinder is illustrated.

The section shown in FIG. 1A represents a cut surface through a carbon fibre nonwoven 2 and a cylinder 10. The carbon fibre nonwoven 2 is applied to the lateral surface of the cylinder 10 by conventional winding without an overlap region. The cut surfaces 3, 4 of both ends of the wound layer run approximately parallel to one another and close to one another. This creates a gap region that runs substantially orthogonally to the outer and inner surface of the carbon fibre nonwoven. The gap region is covered with carbonisable binder 5. The carbon fibre nonwoven does not join together in the gap region because all the fibres are cut off at the cut surfaces 3, 4 and do not extend out from one cut surface 3 into the other cut surface 4. The gap region should have exactly the same width everywhere, which width is as narrow as possible; this can only be achieved with great effort.

The section shown in FIG. 1B represents a cut surface through a carbon fibre nonwoven 2 that is applied by conventional winding with an overlap region 6 to the cylinder 10. In the overlap region 6, the carbon fibre nonwoven is applied in multiple layers. A small overlap region 6 is shown by way of example. The carbon fibre nonwoven 2 can, however, also be longer and wound up in multiple layers all around. Regardless of the size of the overlap region 6, the carbon fibre nonwoven 2 is connected in a spiral all around because the fibres run within the spirally wound carbon fibre nonwoven 2. The fibres do not run from one layer into the next layer located further outside or further inside.

FIG. 2 is a section through a self-supporting hollow cylindrical carbon fibre construction 1, comprising a carbon fibre nonwoven 2, which is continuous between the inner lateral surface 7 and the outer lateral surface 8 of the carbon fibre construction 1 all around.

### EMBODIMENT 1

A method based on BELTEX technology was selected from the known methods for the production of mechanically strengthened nonwovens by means of circular needling, and a hollow cylindrical starting fibre construction was thus produced by circular needling of an uncompacted web of fibres. 100% viscose fibres were used to produce the web (3.0 dtex, cut length 65 mm). The hollow cylindrical starting fibre construction obtained had a length of 830 mm, an inside diameter of 600 mm, an outside diameter of 740 mm and thus a wall thickness of 70 mm. The weight of the starting fibre construction was 27 kg. This results in a volume of the starting fibre construction of 122,289 cm³ and a density calculated from this of 0.22 g/cm³.

This starting fibre construction was subjected to a first high-temperature treatment. For this purpose, it was placed on a cylindrical metal shaping body having a diameter of 430 mm and subjected to a first temperature treatment (carbonisation) in a combustion container in a furnace at 900° C. under a protective gas atmosphere. After this temperature treatment, cooling took place and the hollow cylindrical carbon fibre construction obtained was then pulled off the shaping body. The carbon fibre construction had a length of 580 mm, an inside diameter of 448 mm, an outside diameter of 548 mm and thus a wall thickness of 50 mm. The weight of the carbon fibre construction was 7 kg. This results in a volume of 45,370 cm³ and a density calculated from this of 0.15 g/cm³. The carbon fibre construction was then additionally subjected to a second high-temperature treatment (graphitisation), no shaping body and combustion container being used. The carbon fibre construction was graphitised at 2,200° C. in a furnace under a protective gas atmosphere. After this high-temperature treatment, the hollow cylindrical carbon fibre construction obtained had a length of 580 mm, an inside diameter of 450 mm, an outside diameter of 550 mm and thus a wall thickness of 50 mm. The weight of the construction was 6.4 kg. This results in a volume of 45,552 cm³ and a density calculated from this of 0.14 g/cm³.

To determine the high-temperature thermal conductivity (according to DIN 51936), a sample was taken of the graphitised carbon fibre construction from both the inner lateral surface and the outer lateral surface. The dimensions of the samples were selected in accordance with the specifications in DIN 51936. A diameter of 20 mm and a length of 3 mm were selected. By weighing the sample, a bulk density according to DIN 51918 of 0.16 g/cm³ could then be determined for the inner lateral surface and a bulk density of 0.15 g/cm³ could be determined for the outer lateral surface.

The roundness of the inside diameter of the carbon fibre construction obtained after the first high-temperature treatment was determined by optical 3D technology (scan) of the hollow cylinder using a COMET® system from Zeiss.

The roundness was determined by recording the largest and smallest measurable inside diameter. The roundness can then be calculated from the difference. A value of ±4 mm was obtained for the carbon fibre construction.

### EMBODIMENT 2

A method based on RONTEX technology was selected from the methods for the production of mechanically strengthened nonwovens by means of circular needling described in the prior art, and a hollow cylindrical starting fibre construction was thus produced by circular needling of an uncompacted web of fibres. 100% oxidised polyacrylonitrile (SGL—PANOX®; available under the designation C63-1.7/1.39-A110) was used to produce the uncompacted web of fibres. The starting fibre construction obtained had a length of 170 mm, an inside diameter of 145 mm, an outside diameter of 170 mm and thus a wall thickness of 12.5 mm. The weight of the construction was 215 g. This resulted in a volume of 1,050 cm³ and a density calculated from this of 0.20 g/cm³.

The starting fibre construction was subjected to a first high-temperature treatment (carbonisation). For this purpose, the construction was placed on a cylindrical shaping body made of metal having a diameter of 130 mm and carbonised in a combustion container in a furnace at 900° C. under a protective gas atmosphere. After this temperature treatment, the mixture was cooled and the hollow cylindrical carbon fibre construction obtained was then pulled off the shaping body. After this high-temperature treatment, the hollow cylindrical carbon fibre construction obtained had a length of 150 mm, an inside diameter of 130 mm, an outside diameter of 152 mm and thus a wall thickness of 11 mm. The weight of the construction was 113 g. This resulted in a volume of the construction of 731 cm³ and a density calculated from this of 0.16 g/cm³.

This carbon fibre construction was then additionally subjected to a second high-temperature treatment (graphitisation), no shaping body and combustion container being used. The construction was graphitised in a furnace at 2,200° C. under a protective gas atmosphere. After this high-temperature treatment, the hollow cylindrical carbon fibre construction obtained had a length of 150 mm, an inside diameter of 131 mm, an outside diameter of 152 mm and thus a wall thickness of 10.5 mm. The weight of the construction was 100 g. This resulted in a volume of 700 cm³ and a density calculated from this of 0.14 g/cm³.

In both embodiments, all of the hollow cylindrical constructions (the starting fibre constructions and the constructions obtained after carbonisation and after graphitisation) were self-supporting. As explained above, they could therefore also be referred to as hollow cylindrical fibre bodies.

### LIST OF REFERENCE NUMERALS

carbon fibre construction 1
carbon fibre nonwoven 2
cut surface 3
cut surface 4
binder 5
overlap region 6
inner lateral surface 7
outer lateral surface 8
cylinder 10

1-16. (canceled)

17. Hollow cylindrical carbon fibre construction, comprising a carbon fibre nonwoven, which is continuous between the inner lateral surface and the outer lateral surface of the carbon fibre construction all around.

18. The carbon fibre construction according to claim 17, wherein the proportion of carbon fibres in the carbon fibre nonwoven is at least 50% by weight.

19. The carbon fibre construction according to claim 17, wherein the carbon fibre nonwoven has a mean density in a range of 0.04 to 0.4 g/cm³.

20. The carbon fibre construction according to claim 17, wherein the carbon fibre nonwoven, which is continuous all around, has a tensile strength of at least 0.01 MPa.

21. The carbon fibre construction according to claim 17, wherein the density of the carbon fibre nonwoven in a region facing the inner lateral surface is higher than the density of the carbon fibre nonwoven in a region facing the outer lateral surface.

22. The carbon fibre construction according to claim 17, wherein the carbon content of the carbon fibres is at least 92% by weight.

23. The carbon fibre construction according to claim 17, wherein the carbon fibres have a BET surface area of 1 to 1500 m²/g.

24. A method for producing a carbon fibre construction according to claim 17, wherein a hollow cylindrical starting fibre construction, which comprises a nonwoven that is continuous between the inner lateral surface and the outer lateral surface of the starting fibre construction all around, is subjected to a pyrolysis process.

25. The method according to claim 24, wherein the pyrolysis process comprises a first temperature treatment at 500 to 1,600° C.

26. The method according to claim 25, wherein the pyrolysis process comprises a second temperature treatment at 1,600 to 3,000° C.

27. The method according to claim 24, wherein the starting fibre construction is drawn onto a cylindrical shaping body and is shrunk onto the cylindrical shaping body during the pyrolysis process.

28. The method according to claim 26, wherein the first temperature treatment takes place after the starting fibre construction has been drawn onto the shaping body, the carbon fibre construction obtained is pulled off the shaping body and the carbon fibre construction pulled off the shaping body is subjected to the second temperature treatment.

29. The method according to claim 24, wherein the BET surface area of the carbon fibres of the carbon fibre construction present after the first or second temperature treatment is increased by gas activation.

30. The method according to claim 24, wherein the fibres of the hollow cylindrical starting fibre construction comprise polyacrylonitrile-based fibres, viscose fibres and/or pitch-based fibres.

31. Carbon fibre construction obtainable according to the methods of claim 24.

32. A device comprising the carbon fibre construction according to claim 17, wherein the carbon fibre construction is an element selected from the group consisting of a high-temperature insulating cylinder, a filter material in a filter candle, a carrier material for filter media, a droplet separator or demister, an electrode material, a resistance-heating element and a catalyst carrier.
